(19) United States
(12) Patent Application Publication
(10) Pub. No.: US 2021/0017690 A1
(43) Pub. Date: Jan. 21, 2021

(54) CLOTHES CARE APPARATUS AND CONTROL METHOD THEREOF

(71) Applicant: Samsung Electronics Co., Ltd., Suwon-si (KR)

(72) Inventors: Juyoung KIM, Suwon-si (KR); Kookjeong SEO, Suwon-si (KR); Jewoo BANG, Suwon-si (KR)

(21) Appl. No.: 16/947,113

(22) Filed: Jul. 17, 2020

(30) Foreign Application Priority Data
Jul. 17, 2019 (KR) 10-2019-0086534

(51) Int. Cl. D06F 39/00; D06F 34/14; D06F 87/00

(52) U.S. Cl. CPC D06F 39/008; D06F 2103/08; D06F 87/00; D06F 34/14

(57) ABSTRACT

A clothes care apparatus aimed to prevent drying errors of clothes, prevent a dry time from increasing, and reduce consumption power. The clothes care apparatus includes: a chamber configured to accommodate clothes; a humidity sensor positioned inside the chamber; a steam generator configured to supply steam to an inside of the chamber; and a controller configured to determine an amount of humidity change inside the chamber based on an output value from the humidity sensor during a steam process, and control the steam generator to supply the steam based on the amount of humidity change.

### CROSS-REFERENCE TO RELATED APPLICATION

This application is based on and claims priority under 35 U.S.C. § 119 to Korean Patent Application No. 10-2019-0086534 filed on Jul. 17, 2019 in the Korean Intellectual Property Office, the disclosure of which is incorporated by reference herein in its entirety.

### BACKGROUND

### 1. Field

The disclosure relates to a clothes care apparatus for smoothing out the wrinkles of clothes and removing dust attached to the clothes or smell of the clothes.

### 2. Description of the Related Art

A clothes care apparatus is equipment for caring clothes, such as drying wet clothes, removing dust attached to clothes or smell permeated clothes, and smoothing out the wrinkles of clothes.

The clothes care apparatus performs a function of supplying hot air to clothes to dry the clothes and a function of spraying steam to clothes to remove the wrinkles of the clothes and remove smell permeated the clothes. The hot air may be supplied by a blower, and the steam may be supplied by a steam generator.

Meanwhile, a typical clothes care apparatus senses the temperature of inside air of the chamber to determine a load of clothes and control a dry time, while performing a dry process of drying the clothes after spraying steam to the clothes. However, the typical clothes care apparatus does not determine a load of clothes during a steam process.

### SUMMARY

Therefore, it is an aspect of the disclosure to provide a clothes care apparatus capable of determining, during a steam process of spraying steam to clothes, an amount of humidity change inside a chamber at an initial stage of the steam process, and adjusting a steam spray time based on the amount of humidity change, thereby preventing drying errors while preventing a dry time from increasing, and a method of controlling the clothes care apparatus.

It is another aspect of the disclosure to provide a clothes care apparatus capable of determining, during a steam process, a water load of clothes based on an amount of humidity change inside a chamber and adjusting a steam spray time based on the water load of the clothes, and a method of controlling the clothes care apparatus.

Additional aspects of the disclosure will be set forth in part in the description which follows and, in part, will be obvious from the description, or may be learned by practice of the disclosure.

In accordance with an aspect of the disclosure, a clothes care apparatus includes: a chamber accommodating clothes; a humidity sensor positioned inside the chamber; a steam generator configured to supply steam to inside of the chamber; and a controller configured to determine an amount of humidity change inside the chamber based on an output value from the humidity sensor during a steam process, and control the steam generator to supply the steam based on the amount of humidity change.

The controller may be further configured to adjust a steam spray time based on the amount of humidity change, and control the steam generator to supply the steam for the steam spray time.

The controller may be further configured to determine the steam spray time as a default steam spray time or reduce the steam spray time to a value that is smaller than the default steam spray time, based on the amount of humidity change.

The controller may be further configured to more reduce the steam spray time at the greater amount of humidity change.

The controller may be further configured to adjust a degree of reduction of the steam spray time based on a kind of clothes.

The clothes care apparatus according to an embodiment of the disclosure may further include a fan configured to cause inside air of the chamber to flow, wherein the controller may be further configured to operate the fan for a preset time and determine the amount of humidity change, at an initial stage of the steam process.

The controller may be further configured to operate at least one of an upper fan positioned above the chamber and configured to move air in a down direction of the chamber or a lower fan positioned below the chamber and configured to move air in an up direction of the chamber.

The amount of humidity change may be an amount of humidity increase inside the chamber after a preset time elapses at an initial stage of the steam process.

The clothes care apparatus according to an embodiment of the disclosure may further include a display, wherein the controller may be further configured to control the display to display the steam spray time.

In accordance with another aspect of the disclosure, a method of controlling a clothes care apparatus includes: measuring humidity inside a chamber during a steam process by using a humidity sensor; determining an amount of humidity change inside the chamber based on an output value from the humidity sensor; and controlling the steam generator to supply steam to inside of the chamber based on the amount of humidity change.

The controlling of the steam generator may include: adjusting a steam spray time based on the amount of humidity change; and controlling the steam generator to supply the steam for the steam spray time.

The adjusting of the steam spray time may include determining the steam spray time as a default steam spray time or reducing the steam spray time to a value that is smaller than the default steam spray time, based on the amount of humidity change.

The adjusting of the steam spray time may include more reducing the steam spray time at the greater amount of humidity change.

The adjusting of the steam spray time may include adjusting a degree of reduction of the steam spray time based on a kind of clothes.

The method according to an embodiment of the disclosure may further include operating a fan configured to cause inside air of the chamber to flow for a preset time, at an initial stage of the steam process.

The operating of the fan may include operating at least one of an upper fan positioned above the chamber and configured to move air in a down direction of the chamber or a lower fan positioned below the chamber and configured to move air in an up direction of the chamber.

The amount of humidity change may be an amount of humidity increase inside the chamber after a preset time elapses at an initial stage of the steam process.

The method according to an embodiment of the disclosure may further include controlling a display to display the steam spray time.

In accordance with another aspect of the disclosure, a clothes care apparatus includes: a chamber accommodating clothes; a humidity sensor positioned inside the chamber; a steam generator configured to supply steam to inside of the chamber; and a controller configured to determine a water load of the clothes based on an output value from the humidity sensor during a steam process, and control the steam generator to supply the steam based on the water load of the clothes.

The controller may be further configured to determine the water load of the clothes based on an amount of humidity change inside the chamber at an initial stage of the steam process, adjust a steam spray time based on the water load of the clothes, and control the steam generator to supply the steam for the steam spray time.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a perspective view of a clothes care apparatus according to an embodiment of the disclosure;

FIG. 2 illustrates an exploded perspective view of a clothes care apparatus according to an embodiment of the disclosure;

FIG. 3 illustrates a cross-sectional view of a clothes care apparatus according to an embodiment of the disclosure;

FIG. 4 illustrates a control block diagram of a clothes care apparatus according to an embodiment of the disclosure;

FIG. 5 illustrates a table for describing water loads of clothes;

FIGS. 6, 7, 8, and 9 illustrates graphs showing humidity changes inside a chamber according to water loads of clothes; and

FIGS. 10, 11, and 12 illustrate flowcharts for describing methods of controlling a clothes care apparatus according to an embodiment of the disclosure.

### DETAILED DESCRIPTION

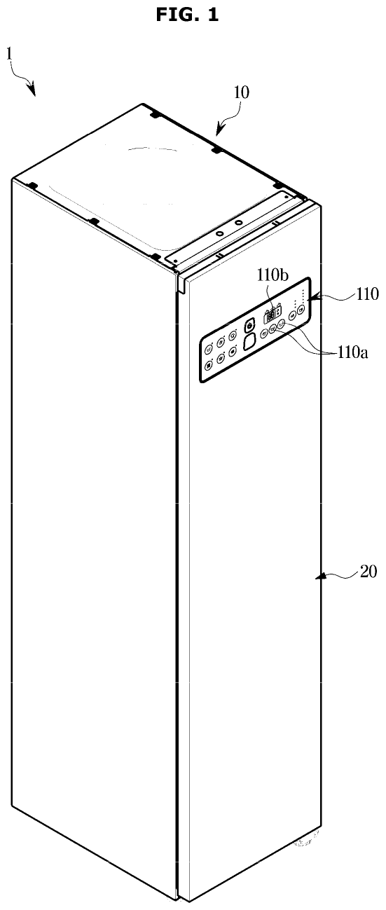

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Like numbers refer to like elements throughout this specification. This specification does not describe all components of the embodiments, and general information in the technical field to which the disclosure belongs or overlapping information between the embodiments will not be described.

The terms “portion”, “device”, “block”, “member”, and “module”, as used herein, may be implemented as software or hardware. In addition, the terms “portion”, “device”, “block”, “member”, and “module” used herein refer to a unit for processing at least one function or operation. Also, the terms “portion”, “device”, “block”, “member”, and “module” may mean at least one process that is processed by at least one software or processor stored in at least one hardware, circuit, or memory. According to some embodiments, the “portion”, “device”, “block”, “member”, and “module” may include at least one component.

Throughout the specification, it will be understood that when a certain portion is referred to as being “connected” to another portion, it can be directly or indirectly connected to the other portion. When a portion is indirectly connected to another portion, it may be connected to the other portion through a wireless communication network. Also, it will be understood that when the terms “includes,” “comprises,” “including,” and/or “comprising,” when used in this specification, specify the presence of a stated component, but do not preclude the presence or addition of one or more other components.

It will be understood that, although the terms “first”, “second”, etc., may be used herein to describe various elements, these elements should not be limited by these terms. The above terms are used only to distinguish one component from another. It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Throughout the disclosure, the expression “at least one of a, b or c” indicates only a, only b, only c, both a and b, both a and c, both b and c, all of a, b, and c, or variations thereof.

Hereinafter, the embodiments of the disclosure will be described with reference to the accompanying drawings.

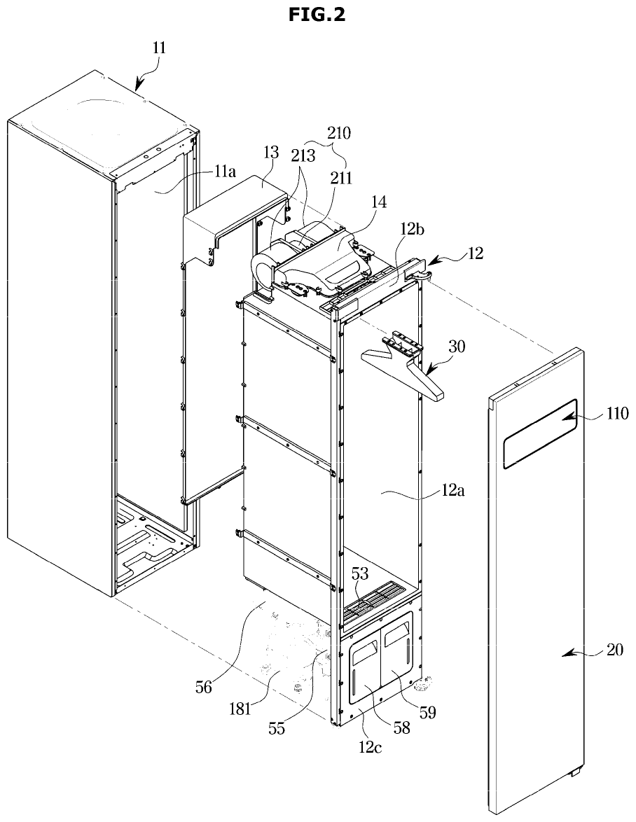

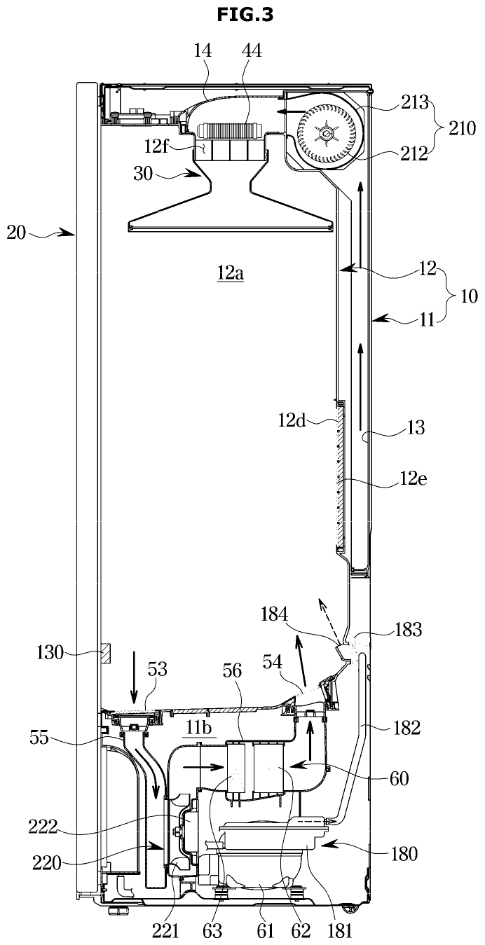

FIG. 1 illustrates a perspective view of a clothes care apparatus according to an embodiment of the disclosure. FIG. 2 illustrates an exploded perspective view of the clothes care apparatus according to an embodiment of the disclosure. FIG. 3 illustrates a cross-sectional view of the clothes care apparatus according to an embodiment of the disclosure.

Referring to FIG. 1, a clothes care apparatus 1 may include a main body 10, and a door 20 rotatably coupled to the main body 10 to open and close a chamber 12a (see FIG. 2). The door 20 may be rotatably installed in one edge of a front side of the main body 10.

The door 20 may include a user interface 110 to enable a user to input commands related to operations of the clothes care apparatus 1. The user interface 110 may be positioned on the front side of the door 20. The user interface 110 may include an inputter 110a such as a button for receiving a user's inputs, and a display 110b for displaying an operation state, etc. of the clothes care apparatus 1. The user interface 110 may include a touch panel. Also, the user interface 110 may be implemented as a touch screen capable of receiving touch inputs.

Referring to FIGS. 2 and 3, the clothes care apparatus 1 may include the chamber 12a installed inside the main body 10 to accommodate clothes. Also, the clothes care apparatus 1 may include a hanger 30 inside the chamber 12a. In FIGS. 2 and 3, a single hanger 30 is shown, however, a plurality of hangers 30 may be provided according to a design.

The main body 10 may include an outer frame 11, an inner frame 12 installed inside the outer frame 11, and upper ducts 13 and 14 (also, referred to as a first upper duct 13 and a second upper duct 14) positioned between the outer frame 11 and the inner frame 12 to guide air to circulate. The outer frame 11 may be in a shape of a rectangular parallelepiped of which the front side opens to form an inside space 11a.

The inner frame 12 may be positioned in the inside space 11a of the outer frame 11. The inner frame 12 may be positioned in the inside space 11a to partition a machine room 11b. The inner frame 12 may form the chamber 12a of which the front side opens to accommodate clothes. The inner frame 12 may include an upper cover 12b positioned above the chamber 12a and forming a space for accommodating an upper fan 210, and a lower cover 12c extending downward from a lower end of the front side of the chamber 12a and covering a front side of the machine room 11b.

A water supply container 58 and a drain container 59 may be removably installed in the lower cover 12c. The water supply container 58 and the drain container 59 may be separable from the lower cover 12c. The water supply container 58 and the drain container 59 may be coupled to the lower cover 12c. The water supply container 58 may supply water to a steam generator 180. The drain container 59 may store water condensed from humid air through a cooling cycle. The water supply container 58 and the drain container 59 may be positioned at other locations.

Referring to FIG. 3, the clothes care apparatus 1 may further include a humidity sensor 130 for detecting humidity inside the chamber 12a. The humidity sensor 130 may be positioned at a lower portion of an inner surface of the door 20, at a bottom plate of the chamber 12a, or around a second inlet 53. However, the position of the humidity sensor 130 is not limited to the bottom plate of the chamber 12a or around the second inlet 53, and the humidity sensor 130 may be positioned at various locations. The humidity sensor 130 may detect humidity inside the chamber 12a in real time or periodically until a dry process terminates from when a steam process starts. Also, the humidity sensor 130 may start detecting humidity inside the chamber 12a, when the clothes care apparatus 1 is powered on.

The machine room 11b may be an area of the inside space 11a, and be partitioned from the chamber 12a by the inner frame 12. The machine room 11b may be formed below the chamber 12a. A heat exchanger 60 (also, referred to as a lower heat exchanger 60) forming a cooling cycle may be installed in the machine room 11b. The heat exchanger 60 may include a compressor 61, a condenser 62, an evaporator 63, and an expansion valve. Meanwhile, the compressor 61 may be an inverter compressor capable of changing revolutions per minute (rpm) or a capacity of compression. The inverter compressor may change a capacity of compression by controlling the rpm, and control an amount of heating of the condenser 62.

Also, the steam generator 180 may be installed in the machine room 11b. The steam generator 180 may supply steam to the chamber 12a. The steam may function to remove the wrinkles or smell of clothes placed inside the chamber 12a. The steam generator 180 may include a steam heater 181 for heating water supplied from the water supply container 58 to generate steam, and a steam supply pipe 182 for guiding the steam generated by the steam heater 181 to a steam spray 183. The steam spray 183 may be positioned at a lower area of a rear plate of the chamber 12a.

Steam generated by the steam heater 181 may move to the steam spray 183 through the steam supply pipe 182, and be supplied to the chamber 12a through a steam outlet 184. The steam outlet 184 may be positioned at the lower area of the rear plate of the chamber 12a. Also, the steam outlet 184 may be positioned around a second discharge opening 54, for example, above the second discharge opening 54.

Meanwhile, the main body 10 of the clothes care apparatus 1 may include a fan 200. The fan 200 may include the upper fan 210 and a lower fan 220. The upper fan 210 is also referred to as a first fan 210, and the lower fan 220 is also referred to as a second fan 220.

The upper fan 210 may be positioned above the chamber 12a behind the upper cover 12b. The upper fan 210 may move air in a down direction of the chamber 12a from above the chamber 12a. The upper fan 210 may include an upper motor 211 for generating a rotation force, an upper blade 212 rotating by the upper motor 211, and a blade case 213 accommodating the upper blade 212. The upper motor 211 is also referred to as a first motor 211, and the upper blade 212 is also referred to as a first blade 212.

A shaft of the upper motor 211 may protrude at its both sides, and the upper blade 212 may be coupled to each of both ends of the shaft. Through the structure, the upper motor 211 may rotate a pair of upper blades 212. The upper fan 210 may be a centrifugal fan for inhaling air in an extension direction of the shaft and discharging the air outward in a radial direction, although not limited thereto. Also, the pair of upper blades 212 may be provided, although not limited thereto. According to a design, a plurality of upper blades 212 may be provided. At both sides of the blade case 213, an intake opening may be formed, and at a front side of the blade case 213, a discharge opening may be formed so that the blade case 213 guides air inhaled at its both sides to the front side.

The lower fan 220 may inhale air to the inside of the machine room 11b, and move the air to the inside of the chamber 12a from below the chamber 12a. In other words, the lower fan 220 may move air in an up direction of the chamber 12a from below the chamber 12a. The lower fan 220 may include a lower motor 222 for generating a rotation force, and a lower blade 221 rotating by the lower motor 222. The lower motor 222 is also referred to as a second motor 222, and the lower blade 221 is also referred to as a second blade 221.

The lower fan 220 may be a centrifugal fan for inhaling air in an extension direction of the shaft and discharging the air outward in a radial direction, although not limited thereto. Also, a single lower blade 221 may be provided, although not limited thereto. According to a design, a plurality of lower blades 221 may be provided. Air flowing by the lower blade 221 may be dried by the lower heat exchanger 60. Therefore, clothes placed inside the chamber 12a may receive dried air from below the chamber 12a.

Referring to FIG. 3, a first inlet 12d may be provided in the rear plate of the chamber 12a. Inside air of the chamber 12a may flow to the upper ducts 13 and 14 through the first inlet 12d. A dust collecting filter 12e for collecting foreign materials such as dust may be positioned in front of or behind the first inlet 12d. Also, in a top plate of the chamber 12a, a first discharge opening 12f may be provided. Air passed through the upper ducts 13 and 14 may be discharged to the chamber 12a through the first discharge opening 12f.

When the upper fan 210 operates, inside air of the chamber 12a may enter the first upper duct 13 through the first inlet 12d. When the inside air of the chamber 12a enters the first upper duct 13, foreign materials such as fine dust existing in the inside air of the chamber 12a may be removed by the dust collecting filter 12e. The air entered the first upper duct 13 may move upward along the first upper duct 13 to be inhaled into the upper fan 210. The air discharged from the upper fan 210 may move along the second upper duct 14 to enter the inside of the chamber 12a through the first discharge opening 12f provided in the top plate of the chamber 12a.

A lower end of the first upper duct 13 may be connected to a lower area of the rear plate of the chamber 12a, and an upper end of the first upper duct 13 may cover the upper fan 210. One end of the second upper duct 14 may be connected to the upper fan 210, and the other end of the second upper duct 14 may be connected to the first discharge opening 12f.

The first discharge opening 12f may include a first inner discharge opening for discharging air to inside of the hanger 30, and a first outer discharge opening positioned to both sides of the first inner discharge opening to discharge air to both sides of clothes hanging on the hanger 30.

Meanwhile, an upper heater 44 may be positioned inside the second upper duct 14. The upper heater 44 may heat air moving by the upper fan 210. Accordingly, hot air may flow to the inside of the chamber 12a through the first discharge opening 12f. As another example, an upper heat exchanger, instead of the upper heater 44, may be provided. The upper heat exchanger may include devices, such as a compressor, a condenser, an evaporator, etc.

In an upper plate of the machine room 11b, that is, in the bottom plate of the chamber 12a, the second inlet 53, the second discharge opening 54, and the steam outlet 184 may be provided. The second inlet 53 may be positioned in a front area of the bottom plate of the chamber 12a, and the second discharge opening 54 and the steam outlet 184 may be positioned in a rear area of the bottom plate of the chamber 12a. However, the second inlet 53, the second discharge opening 54, and the steam outlet 184 may be positioned at other locations.

Inside air of the chamber 12a may enter a first lower duct 55 through the second inlet 53. One end of the first lower duct 55 may be connected to the second inlet 53, and the other end of the first lower duct 55 may be connected to the lower fan 220. The air entered the first lower duct 55 may move to a second lower duct 56 via the lower fan 220.

Inside the second lower duct 56, the evaporator 63 and the condenser 62 of the lower heat exchanger 60 may be positioned. The evaporator 63 may absorb heat from inside air of the second lower duct 56. Water included in the air may be condensed when the air passes through the evaporator 63, and the condensed water may be stored in the drain container 59 through a preset path. The condenser 62 may be positioned downstream from the evaporator 63 on a flow path of air. The air of which the humidity is lowered by passing through the evaporator 63 may be heated when passing through the condenser 62. By passing through the evaporator 63 and the condenser 62, temperature of the air may increase and humidity of the air may be lowered. As a result, high-temperature dry air may enter the chamber 12a through the second discharge opening 54. The clothes care apparatus 1 may dehumidify the inside of the chamber 12a and dry clothes through the above-described process.

A conventional clothes care apparatus sprays, when performing a steam process, steam to the inside of a chamber, without determining a water load of clothes. In other words, the typical clothes care apparatus performs a steam process without distinguishing a case of accommodating dry clothes inside the chamber 12a from a case of accommodating wet clothes inside the chamber 12a. However, when the same steam process is applied to wet clothes and dry clothes, the wet clothes may be not completely dried, so that a time of a dry process may increase. That is, the typical clothes care apparatus may adjust a dry time according to a dry rate of clothes during a dry process, without adjusting a steam spray time during a steam process performed before the dry process.

Because a process of heating water to generate steam and a process of drying clothes consume a lot of power, an increase of a dry time lowers energy efficiency. Also, because spraying a large amount of steam onto wet clothes is unnecessary and deteriorates energy efficiency, it may be needed to optimize the steam process according to a water load of clothes.

Hereinafter, operations of the clothes care apparatus 1 for optimizing a steam process according to a water load of clothes will be described.

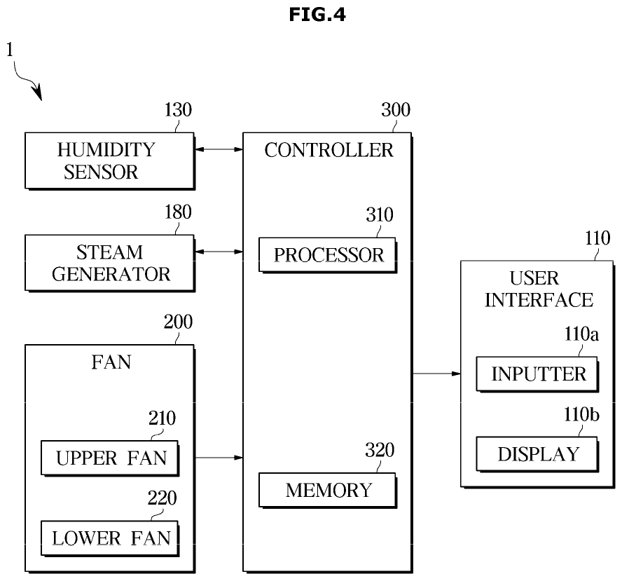

FIG. 4 illustrates a control block diagram of the clothes care apparatus 1 according to an embodiment of the disclosure.

Referring to FIG. 1, the clothes care apparatus 1 according to an embodiment of the disclosure may include the user interface 110, the humidity sensor 130, the steam generator 180, the fan 200, and a controller 300. The controller 300 may be electrically connected to the user interface 110, the humidity sensor 130, the steam generator 180, and the fan 200. Also, the controller 300 may control components of the clothes care apparatus 1 electrically connected thereto.

The controller 300 may include a memory 320 for memorizing and/or storing programs, instructions, and data for controlling operations of the clothes care apparatus 1, and a processor 310 for generating control signals for controlling operations of the clothes care apparatus 1 based on the programs, instructions, and data memorized and/or stored in the memory 320. The processor 310 and the memory 320 may be implemented as separate chips, or integrated into a single chip. Also, the controller 300 may include a plurality of processors and a plurality of memories.

The processor 310 may include a logic circuit and an arithmetic circuit, as hardware. The processor 310 may process data according to a program and/or instruction provided from the memory 320, and generate a control signal according to the result of the processing. For example, when a user controls the user interface 110 to input a command of selecting a care course, the clothes care apparatus 1 may perform a clothes care operation corresponding to the selected care course.

The memory 320 may include a volatile memory, such as Static Random Access Memory (S-RAM) and Dynamic Random Access Memory (D-RAM), for temporarily storing data, and a non-volatile memory, such as Read Only Memory (ROM), Erasable Programmable Read Only Memory (EPROM) and Electrically Erasable Programmable Read Only Memory (EEPROM), for storing data for a long time.

The user interface 110 may include the inputter 110a such as a button for receiving a user's input, and the display 110b for displaying an operation state, etc. of the clothes care apparatus 1. The user interface 110 may receive various commands from the user. The controller 300 may process a command input through the user interface 110, and control an operation of the clothes care apparatus 1 corresponding to the command.

More specifically, the user interface 110 may receive information about a care course of the clothes care apparatus 1 from a user. For example, the user may control the user interface 110 to select a care course. The care course may include a standard course, a sterilization course, a fine dust removing course, and a quick course, etc.

Also, a care course may be automatically selected without receiving any input from a user. The clothes care apparatus 1 may identify clothes to select a care course. In order to automatically select a care course, the clothes care apparatus 1 may further include a camera. The controller 300 may identify clothes based on an image of the clothes photographed by the camera. Also, the clothes care apparatus 1 may further include a tag identifying device for identifying a tag attached to clothes, and select a care course based on information included in the tag.

Each of the care courses may include processes, such as a steam process, a dry process, a cleaning process, etc. For example, the standard course may be executed in order of a steam process, a dry process, and a cleaning process. Also, the care course may be configured with various processes according to a design. However, the execution order of the processes may change, another process may be added, or some of the processes may be omitted.

Operation parameters of processes configuring the care courses may be set to different values according to the care courses. The operation parameters may mean execution times of the respective processes. For example, an operation parameter of the steam process may include an execution time of the steam process, and an execution time of the steam process in the standard course may be set to be different from an execution time of the steam process in the quick course. Also, an execution time of the dry process in the standard course may be set to be different from an execution time of the dry process in the quick course.

The controller 300 may control the display 110b to display at least one of a total execution time of a care course or an execution time of each process. Also, the controller 300 may control the display 110b to display a steam spray time.

Meanwhile, the steam process may include a steam generation operation of generating steam, a steam spray operation of spraying steam to the inside of the chamber 12a, and a steam stabilization operation of stabilizing steam inside the chamber 12a. The steam spray operation may include dispersing steam to the inside of the chamber 12a. Also, the steam process may further include an operation of determining a water load of clothes. A water load of clothes may be determined based on an amount of humidity change inside the chamber 12a at an initial stage of the steam process. The amount of humidity change means an amount of humidity increase inside the chamber 12a after a preset time elapses at an initial stage of the steam process. The water load of clothes may be classified into large, medium, and small according to the amount of humidity change.

For example, in the case of the standard course, execution times of the steam process, which are basically set, may be as follows. A time for determining a water load of clothes may be 2 minutes, a time for generating steam may be 2 minutes, a time for spraying steam may be 5 minutes, and a time for stabilizing steam may be 1 minute. The times may have been set for clothes having no water load, that is, dry clothes.

As described above, when the same steam process is applied to wet clothes and dry clothes, the wet clothes may be not completely dried, so that a time of a dry process may increase. Also, energy efficiency may deteriorate. Accordingly, the clothes care apparatus 1 according to an embodiment of the disclosure may detect a water load of clothes based on an amount of humidity change inside the chamber 12a at an initial stage of the steam process to adjust a steam spray time, thereby optimizing the steam process and simultaneously preventing consumption power from increasing.

A user may input information about at least one of a number or kind of clothes by using the user interface 110. The kind of clothes may be classified into a wool material including wool or a wool blend, a cotton material including cotton or a cotton blend, a rayon material, a silk material, a polyester material, etc. Also, the controller 300 may automatically identify a kind of clothes. For example, the controller 300 may identify a kind of clothes based on information included in a tag of the clothes.

Operation parameters of processes configuring the care courses may be set to different values based on at least one of a number of clothes or a kind of clothes. For example, execution times of a steam process for a wool material may be configured with a steam generation time of 2 minutes, a steam spray time of 3 minutes, and a steam stabilization time of 0.5 minutes. Also, execution times of a steam process for a silk material or a rayon material may be configured with a steam generation time of 2 minutes, a steam spray time of 2 minutes, and a steam stabilization time of 0.5 minutes. However, a time for determining a water load of clothes in the steam process may be the same for all care courses or all kinds of clothes. The controller 300 may adjust the steam spray time of the steam process based on a water load of clothes and a kind of clothes.

The humidity sensor 130 may measure humidity inside the chamber 12a. The humidity sensor 130 may measure at least one of relative humidity or absolute humidity. When the clothes care apparatus 1 is powered on, the humidity sensor 130 may start detecting humidity inside the chamber 12a. The humidity sensor 130 may detect humidity inside the chamber 12a in real time or periodically.

Also, the humidity sensor 130 may detect humidity inside the chamber 12a during the steam process. The controller 300 may determine an amount of humidity change inside the chamber 12a based on an output value from the humidity sensor 130. Also, the controller 300 may determine a water load of clothes based on an amount of humidity change inside the chamber 12a for a preset time. More specifically, the controller 300 may determine an amount of humidity change based on humidity inside the chamber 12a, measured for a preset time at an initial stage of the steam process. The preset time may have been set in advance, and for example, the preset time may be 2 minutes. The amount of humidity change may mean an amount of humidity increase inside the chamber 12a after the preset time elapses at the initial stage of the steam process.

The clothes care apparatus 1 may further include a temperature sensor. The temperature sensor may be positioned at the lower portion of the inner surface of the door 20 to measure inside temperature of the chamber 12a. In other words, the temperature sensor may measure temperature of inside air of the chamber 12a. Also, the temperature sensor may be positioned inside the steam generator 180 to measure temperature of water stored in the steam generator 180. However, the position of the temperature sensor is not limited, and the temperature sensor may be positioned at various locations. Also, the clothes care apparatus 1 may further include various sensors, such as a weight sensor, a dust measuring sensor, etc.

The steam generator 180 may supply steam to the chamber 12a. The steam generator 180 may heat water supplied from the water supply container 58 to generate steam, and spray the steam to the chamber 12a. For example, the steam generator 180 may spray steam of about 40 cc per minute to the inside of the chamber 12a. The controller 300 may control the steam generator 180 to supply an appropriate amount of steam to the chamber 12a based on an amount of humidity change inside the chamber 12a during the steam process. The controller 300 may adjust and/or determine a steam spray time based on the amount of humidity change determined at the initial stage of the steam process, and control the steam generator 180 to supply steam to the chamber 12a for the steam spray time.

The controller 300 may control the steam generator 180 to supply steam to the chamber 12a based on a water load of clothes. The controller 300 may control the steam generator 180 to supply steam to the chamber 12a for a steam spray time determined according to a water load of clothes.

Also, the controller 300 may control the steam generator 180 to heat water until temperature of water stored in the steam generator 180 reaches preset temperature (for example, 60° C.). Thereby, clothes may be prevented in advance from being damaged by high temperature. When the temperature of water stored in the steam generator 180 reaches the preset temperature, the controller 300 may control the steam generator 180 to supply steam to the inside of the chamber 12a.

The fan 200 may include the upper fan 210 and the lower fan 220. The upper fan 210 is also referred to as the first fan 210, and the lower fan 220 is also referred to as the second fan 220. The upper fan 210 may move air to the inside of the chamber 12a from above the chamber 12a, and the lower fan 220 may move air to the inside of the chamber 12a from below the chamber 12a. The controller 300 may operate at least one of the upper fan 210 or the lower fan 220, and accordingly, inside air of the chamber 12a may flow.

Particularly, the controller 300 may operate the fan 200 for the preset time at the initial stage of the steam process. The reason is to quickly measure a change of humidity inside the chamber 12a. When wet clothes are accommodated in the chamber 12a, the controller 300 may cause inside air of the chamber 12a to flow, thereby facilitating evaporation of water included in the wet clothes. Accordingly, a change of humidity inside the chamber 12a may be measured more quickly than when the fan 200 does not operate. The preset time may have been set in advance, and for example, the preset time may be 2 minutes. Also, the preset time may mean a time for which the fan 200 operates while none of the steam generator 180, the upper heater 44, the compressor 61, etc. operates. Also, the fan 200 may operate for a part of the preset time.

In other words, the controller 300 may operate the fan 200 for the preset time at the initial stage of the steam process, and then measure an amount of humidity change inside the chamber 12a. That is, the controller 300 may measure an amount of humidity increase of the chamber 12a. As another example, the controller 300 may operate the compressor 61, etc. together with the fan 200, for the preset time at the initial stage of the steam process. Also, the controller 300 may measure an amount of humidity change inside the chamber 12a after the preset time elapses at the initial stage of the steam process, without operating any one of the fan 200, the compressor 61, etc.

Meanwhile, the controller 300 may operate the fan 200 to disperse steam supplied from the steam generator 180 to the chamber 12a.

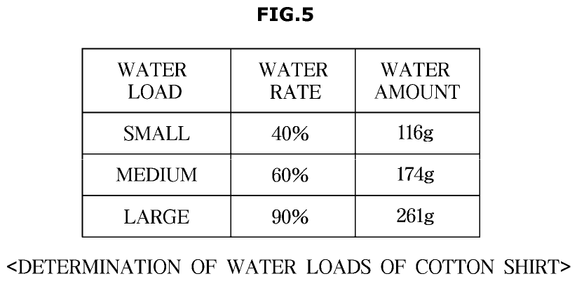

FIG. 5 illustrates a table for describing water loads of clothes.

Referring to FIG. 5, a water load of clothes may mean an amount and/or rate of water included in the clothes. The more amount of water included in clothes, the larger water load of the clothes. FIG. 5 classifies water loads of a cotton shirt having a weight of 290 g. When an amount of water included in the cotton shirt is 116 g, a water rate may become 40% and a water load may be defined as ‘small’. Also, when an amount of water included in the cotton shirt is 174 g, a water rate may become 60% and a water load may be defined as ‘medium’. Also, when an amount of water included in the cotton shirt is 261 g, a water rate may become 90% and a water load may be defined as ‘large’. Also, when no water is included in the cotton shirt, it may be defined that there is no water load. Values shown in FIG. 5 are examples for easy understanding, not intended to limit the disclosure.

As described above, when the same steam process is applied to clothes having a large water load and clothes having a small water load, the clothes having the large water load may be not completely dried, or a dry time for drying the clothes having the large water load may increase significantly. The increase of the dry time may cause an increase of consumption power. Accordingly, a steam spray time may need to be adjusted according to a water load of clothes accommodated in the chamber 12a, that is, according to an amount of water included in the clothes.

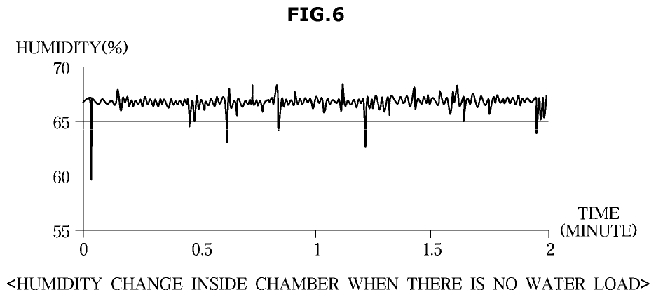

FIGS. 6, 7, 8, and 9 illustrate graphs showing humidity changes inside the chamber 12a according to water loads of clothes.

As described above, the humidity sensor 130 may detect humidity inside the chamber 12a. After clothes are accommodated in the chamber 12a, the controller 300 may determine an amount of humidity change inside the chamber 12a based on an output value from the humidity sensor 130 during a steam process. The amount of humidity change may be determined based on humidity inside the chamber 12a, measured for a preset time at an initial stage of the steam process. The preset time may have been set in advance, and for example, the preset time may be 2 minutes. That is, the amount of humidity change may mean an amount of humidity increase inside the chamber 12a after the preset time elapses at the initial stage of the steam process. Also, the controller 300 may determine a water load of clothes based on the amount of humidity change inside the chamber 12a. FIGS. 6, 7, 8, and 9 show relative humidity changes inside the chamber 12a after cotton shirts having different water loads are accommodated in the chamber 12a.

Referring to FIG. 6, it is seen that, when clothes having no water load, that is, dry clothes are accommodated in the chamber 12a, there is little humidity change inside the chamber 12a. That is, an amount of relative humidity change inside the chamber 12a for the preset time may be close to zero. Accordingly, to remove wrinkles of the clothes having no water load, a steam spray time may be set to a maximum steam spray time. The steam spray time for the clothes having no water load may be defined as a default steam spray time. The default steam spray time may be, for example, 5 minutes.

In other words, when an amount of humidity change inside the chamber 12a is within a first range, the controller 300 may determine that clothes has no water load. Also, when the amount of humidity change inside the chamber 12a is within the first range, the controller 300 may maintain the default steam spray time without reducing the default steam spray time. The first range may be a range of 0% to 5%.

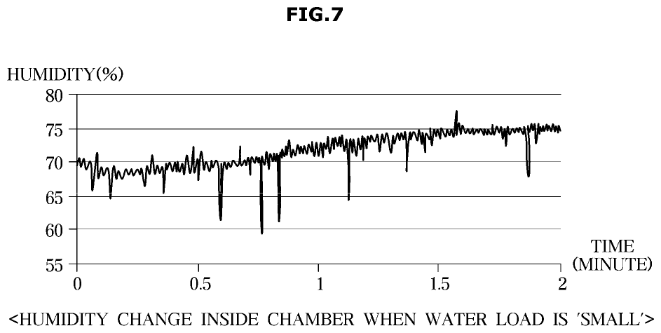

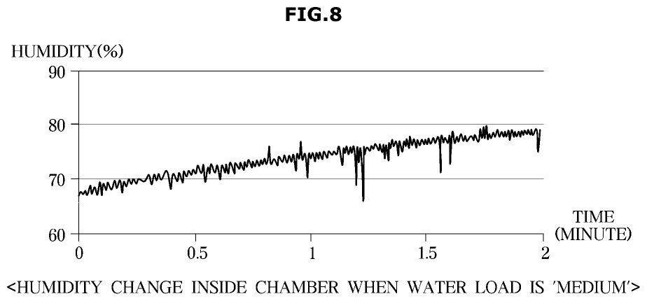

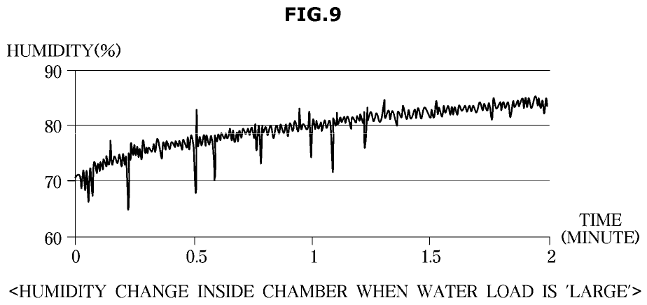

Referring to FIG. 7, when clothes having a water load ‘small’ are accommodated in the chamber 12a, humidity inside the chamber 12a may rise by about 6% for the preset time. Referring to FIG. 8, when clothes having a water load ‘medium’ are accommodated in the chamber 12a, humidity inside the chamber 12a may rise by about 10% for the preset time. Referring to FIG. 9, when clothes having a water load ‘large’ are accommodated in the chamber 12a, humidity inside the chamber 12a may rise by about 15% for the preset time. As such, the larger water load of clothes, that is, the more amount of water included in the clothes, the greater amount of humidity change inside the chamber 12a. However, values shown in FIGS. 6, 7, 8, and 9 are examples, and the amounts of humidity changes may change depending on experiment environments. Because an amount of humidity change is determined based on an amount of water included in clothes accommodated in the chamber 12a, the amount of humidity change may be determined regardless of a number of the clothes.

When an amount of humidity change inside the chamber 12a is within a second range, the controller 300 may determine a water load of clothes as ‘small’. Also, when the amount of humidity change inside the chamber 12a is within the second range, the controller 300 may reduce the steam spray time by a first time. That is, the controller 300 may determine a time reduced by the first time from the default steam spray time, as a new steam spray time. The second range may be a range of 5% to 10%, and the first time may be 1 minute.

Also, when an amount of humidity change inside the chamber 12a is within a third range, the controller 300 may determine a water load of clothes as ‘medium’. Also, when the amount of humidity change inside the chamber 12a is within the third range, the controller 300 may reduce the steam spray time by a second time. That is, the controller 300 may determine a time reduced by the second time from the default steam spray time, as a new steam spray time. The third range may be a range of 10% to 15%, and the second time may be 2 minute.

Also, when an amount of humidity change inside the chamber 12a is within a fourth range, the controller 300 may determine a water load of clothes as ‘large’. Also, when the amount of humidity change inside the chamber 12a is within the fourth range, the controller 300 may reduce the steam spray time by a third time. That is, the controller 300 may determine a time reduced by the third time from the default steam spray time, as a new steam spray time. The fourth range may be a range of 15% or more, and the third time may be 3 minute.

Meanwhile, the first range, the second range, the third range, and the fourth range may change according to a design. Also, the default steam spray time, the first time, the second time, the third time, and the fourth time may change according to a design.

As such, the controller 300 may adjust a steam spray time based on an amount of humidity inside the chamber 12a during a steam process. In other words, the controller 300 may determine a steam spray time as the default steam spray time or reduce a steam spray time to a value that is smaller than the default steam spray time, based on an amount of humidity change inside the chamber 12a determined at an initial stage of the steam process. The controller 300 may more reduce the steam spray time at the greater amount of humidity change inside the chamber 12a. That is, the more amount of water included in clothes, the greater reduction of the steam spray time. Accordingly, energy that is used for spraying steam may be reduced.

Also, the controller 300 may adjust a degree of reduction of the steam spray time based on a kind of clothes. For example, as described above, in a case of cotton clothes, the steam spray time may be reduced by 1 minute according to a water load. However, in a case of wool clothes, the steam spray time may be reduced by 1.5 minutes according to a water load.

Also, the controller 300 may control the steam generator 180 based on an adjusted steam spray time. That is, the controller 300 may control the steam generator 180 to spray steam to the chamber 12a for an adjusted steam spray time. The controller 300 may perform a dry process after terminating the steam process.

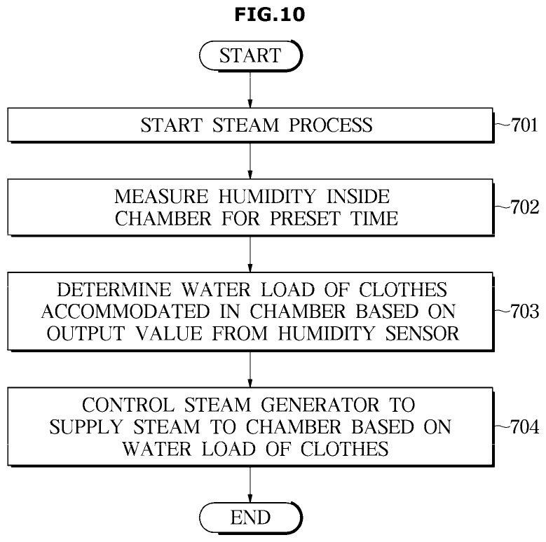

FIGS. 10, 11, and 12 illustrate flowcharts for describing methods of controlling the clothes care apparatus 1 according to an embodiment of the disclosure.

Referring to FIG. 10, the controller 300 of the clothes care apparatus 1 according to an embodiment of the disclosure may control, when a steam process starts in operation 701, the humidity sensor 130 to measure humidity inside the chamber 12a for a preset time, in operation 702. The controller 300 may determine a water load of clothes accommodated in the chamber 12a based on an output value from the humidity sensor 130, in operation 703. The water load of clothes may mean a water amount and/or a water rate included in the clothes. Then, the controller 300 may control the steam generator 180 to supply steam to the chamber 12a based on the water load of the clothes, in operation 704.

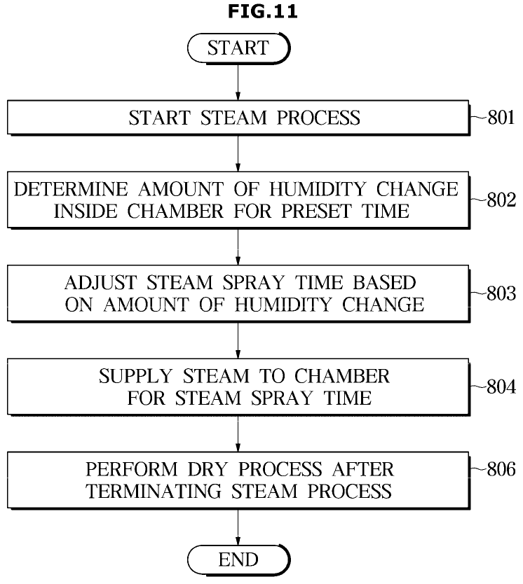

FIG. 11 specifically describes a method of controlling the clothes care apparatus 1 according to an embodiment of the disclosure. Referring to FIG. 11, the controller 300 of the clothes care apparatus 1 according to an embodiment of the disclosure may control, when a steam process starts in operation 801, the humidity sensor 130 to measure humidity inside the chamber 12a for a preset time, and determine an amount of humidity change, in operation 802. The amount of humidity change may be determined at an initial stage of the steam process. The amount of humidity change may mean an amount of humidity increase inside the chamber 12a after the preset time elapses at the initial stage of the steam process. The controller 300 may determine a water load of clothes based on the amount of humidity change inside the chamber 12a. The preset time may have been determined in advance, and for example, the preset time may be 2 minutes.

The controller 300 may adjust a steam spray time based on the amount of humidity change inside the chamber 12a, in operation 803. Thereafter, the controller 300 may control the steam generator 180 to supply steam to the chamber 12a for the adjusted steam spray time, in operation 804. The controller 300 may perform a dry process after terminating the steam process, in operation 806.

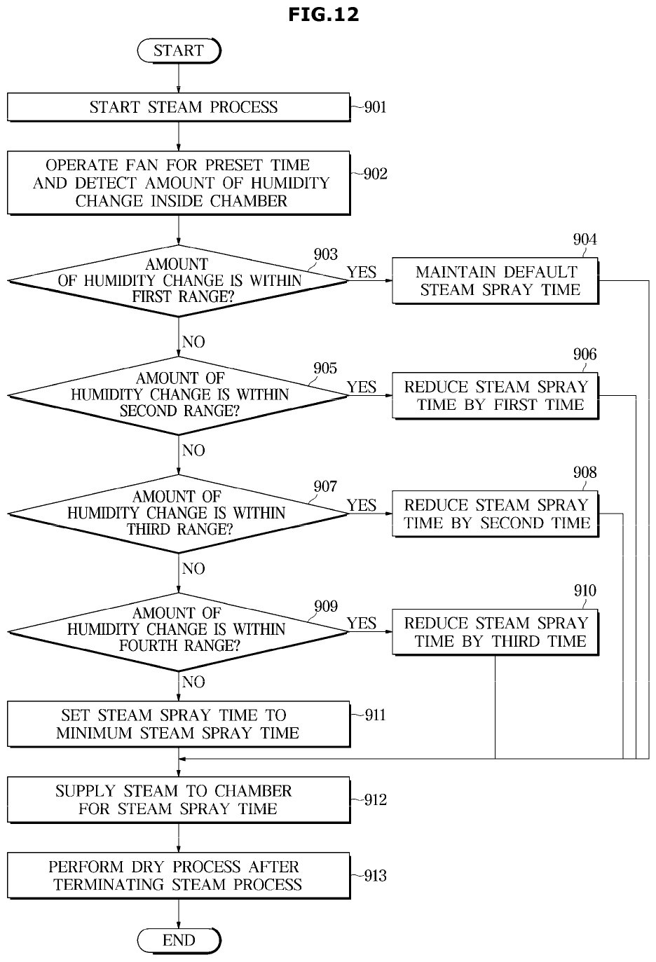

FIG. 12 more detailly describes a method of controlling the clothes care apparatus 1 shown in FIG. 11. Referring to FIG. 12, the controller 300 of the clothes care apparatus 1 according to an embodiment of the disclosure may operate, when a steam process starts in operation 901, the fan 200 for a preset time, and detect an amount of humidity change inside the chamber 12a based on an output value from the humidity sensor 130, in operation 902. The reason of operating the fan 200 is to quickly measure a humidity change inside the chamber 12a. The preset time may have been set in advance, and for example, the preset time may be 2 minutes. Also, the preset time may mean a time for which the fan 200 operates while none of the steam generator 180, the upper heater 44, the compressor 61, etc. operates. The fan 200 may operate for a part of the preset time.

As another example, the controller 300 may operate the compressor 61, etc. together with the fan 200 for the preset time at an initial stage of the steam process. Also, the controller 300 may measure an amount of humidity change inside the chamber 12a after the preset time elapses at the initial state of the steam process, without operating any one of the fan 200, the compressor 61, etc.

When the amount of humidity change inside the chamber 12a is within a first range, the controller 300 may maintain a default steam spray time without reducing the default steam spray time, in operations 903 and 904. The first range may be a range of 0% to 5%. Also, when the amount of humidity change inside the chamber 12a for the preset time is within a second range, the controller 300 may reduce the steam spray time by a first time, in operations 905 and 906. Also, when the amount of humidity change inside the chamber 12a for the preset time is within a third range, the controller 300 may reduce the steam spray time by a second time, in operations 907 and 908. Also, when an amount of humidity change inside the chamber 12a for the preset time is within a fourth range, the controller 300 may reduce the steam spray time by a third time, in operations 909 and 910.

When the amount of humidity change inside the chamber 12a for the preset time exceeds the fourth range, the controller 300 may set the steam spray time to a minimum steam spray time, in operation 911. The minimum steam spray time may be 0 minutes.

Thereafter, the controller 300 may control the steam generator 180 to spray steam to the chamber 12a for the adjusted steam spray time, in operation 912. The controller 300 may perform a dry process after terminating the steam process, in operation 913.

Meanwhile, the memory 320 may store at least one instruction set to enable the processor 310 to determine an amount of humidity change inside the chamber 12a based on an output value from the humidity sensor 130 during a steam process, and control the steam generator 180 to supply steam to the inside of the chamber 12a based on the amount of humidity change. Also, the memory 320 may store at least one instruction set to enable the processor 310 to determine a water load of clothes based on an output value from the humidity sensor 130 during the steam process, and control the steam generator 180 to supply steam to the inside of the chamber 12a based on the water load of the clothes.

As described above, the clothes care apparatus 1 according to an aspect and the method of controlling the clothes care apparatus 1 may prevent drying errors and prevent a dry time from increasing by determining an amount of humidity change inside the chamber 12a and adjusting a steam spray time based on the amount of humidity change during a steam process of spraying steam to clothes. Accordingly, clothes may be optimally cared and a reduction of consumption power may be achieved.

The clothes care apparatus 1 according to an aspect and the method of controlling the clothes care apparatus 1 may determine a water load of clothes based on an amount of humidity change inside the chamber 12a, and adjust a steam spray time based on the water load of the clothes, during a steam process.

Although the present disclosure has been described with various embodiments, various changes and modifications may be suggested to one skilled in the art. It is intended that the present disclosure encompass such changes and modifications as fall within the scope of the appended claims.

What is claimed is:

1. A clothes care apparatus comprising:
a chamber configured to accommodate clothes;
a humidity sensor positioned inside the chamber;
a steam generator configured to supply steam to an inside of the chamber; and
a controller configured to:
determine an amount of humidity change inside the chamber based on an output value from the humidity sensor during a steam process, and
control the steam generator to supply the steam based on the amount of humidity change.

2. The clothes care apparatus according to claim 1, wherein the controller is further configured to:
adjust a steam spray time based on the amount of humidity change; and
control the steam generator to supply the steam for the steam spray time.

3. The clothes care apparatus according to claim 2, further comprising a display,
wherein the controller is further configured to control the display to display the steam spray time.

4. The clothes care apparatus according to claim 2, wherein the controller is further configured to determine the steam spray time as a default steam spray time or reduce the steam spray time to a value that is smaller than the default steam spray time, based on the amount of humidity change.

5. The clothes care apparatus according to claim 4, wherein the controller is further configured to reduce the steam spray time by an amount correlated with the amount of humidity change.

6. The clothes care apparatus according to claim 4, wherein the controller is further configured to adjust a degree of reduction of the steam spray time based on a kind of the clothes.

7. The clothes care apparatus according to claim 1, further comprising a fan configured to cause inside air of the chamber to flow,
wherein, at an initial stage of the steam process, the controller is further configured to operate the fan for a preset time and determine the amount of humidity change.

8. The clothes care apparatus according to claim 7, wherein the controller is further configured to operate at least one of:
an upper fan positioned above the chamber and configured to move air in a down direction of the chamber; or
a lower fan positioned below the chamber and configured to move air in an up direction of the chamber.

9. The clothes care apparatus according to claim 1, wherein the amount of humidity change is an amount of humidity increase inside the chamber after a preset time elapses at an initial stage of the steam process.

10. A method of controlling a clothes care apparatus, comprising:
measuring humidity inside a chamber during a steam process by using a humidity sensor;
determining an amount of humidity change inside the chamber based on an output value from the humidity sensor; and
controlling a steam generator to supply steam to an inside of the chamber based on the amount of humidity change.

11. The method according to claim 10, wherein the controlling of the steam generator comprises:
adjusting a steam spray time based on the amount of humidity change; and
controlling the steam generator to supply the steam for the steam spray time.

12. The method according to claim 11, further comprising controlling a display to display the steam spray time.

13. The method according to claim 11, wherein the adjusting of the steam spray time comprises determining the steam spray time as a default steam spray time or reducing the steam spray time to a value that is smaller than the default steam spray time, based on the amount of humidity change.

14. The method according to claim 13, wherein the adjusting of the steam spray time comprises reducing the steam spray time by an amount correlated with the amount of humidity change.

15. The method according to claim 13, wherein the adjusting of the steam spray time comprises adjusting a degree of reduction of the steam spray time based on a kind of clothes accommodated by the chamber.

16. The method according to claim 10, further comprising operating a fan configured to cause inside air of the chamber to flow for a preset time at an initial stage of the steam process.

17. The method according to claim 16, wherein the operating of the fan comprises operating at least one of:
an upper fan positioned above the chamber and configured to move air in a down direction of the chamber; or
a lower fan positioned below the chamber and configured to move air in an up direction of the chamber.

18. The method according to claim 10, wherein the amount of humidity change is an amount of humidity increase inside the chamber after a preset time elapses at an initial stage of the steam process.

19. A clothes care apparatus comprising:
a chamber configured to accommodate clothes;
a humidity sensor positioned inside the chamber;
a steam generator configured to supply steam to an inside of the chamber; and
a controller configured to:
determine a water load of the clothes based on an output value from the humidity sensor during a steam process, and
control the steam generator to supply the steam based on the water load of the clothes.

20. The clothes care apparatus according to claim 19, wherein the controller is further configured to:
determine the water load of the clothes based on an amount of humidity change inside the chamber at an initial stage of the steam process;
adjust a steam spray time based on the water load of the clothes; and
control the steam generator to supply the steam for the steam spray time.
